(19) United States
(12) Patent Application Publication
(10) Pub. No.: US 2008/0142311 A1
(43) Pub. Date: Jun. 19, 2008

(54) Pit Buffer Assembly for an Elevator System

(76) Inventor: John Ferrisi, Southington, CT (US)

Correspondence Address: CARLSON GASKEY & OLDS, 400 W MAPLE STE 350, BIRMINGHAM, MI, 48009, US

(21) Appl. No.: 11/815,341

(22) PCT Filed: Feb. 9, 2005
(86) PCT No.: PCT/US05/04271

§ 371 Date: Aug. 2, 2007

(51) Int. Cl. B66B 5/28

(52) U.S. Cl. 187/343

(57) ABSTRACT

An elevator system (20) includes a buffer assembly (30) having buffers (32) spaced apart such that at least a portion of a counterweight (24) is received between the buffers (32) before the buffers interact with the counterweight. In a disclosed example, a strike member (60) has strike surfaces (62) that contact ends (38) of the buffers (32) after a substantial portion of the counterweight (24) has proceeded vertically below the ends (38) of the buffers.

### FIELD OF THE INVENTION

This invention generally relates to elevator systems. More particularly, this invention relates to a pit buffer assembly for use in an elevator system.

### DESCRIPTION OF THE RELATED ART

Elevator systems include a variety of devices for controlling the movement or position of an elevator car, counterweight or both. One such device is known as a pit buffer and provides a cushion or energy-absorbing effect at the bottom of a hoistway under certain conditions. Various pit buffers are known.

One shortcoming of pit buffer arrangements is that they take up valuable space. A pit buffer must be of sufficient size to provide the necessary energy-absorbing capacity. Buffers must have a sufficient height to provide a sufficient stroke to achieve the energy-absorbing capacity needed to provide adequate cushion at the bottom of a hoistway. The requirement of sufficient buffer size typically requires a deeper pit at the bottom of a hoistway, for example. This can result in additional building expense, which is undesirable.

It is desirable to provide a pit buffer arrangement that enhances the economies associated with having adequate cushioning or energy-absorbing capacity at the bottom of a hoistway. This invention provides such an arrangement.

### SUMMARY OF THE INVENTION

An example buffer assembly that is useful in a pit of an elevator system includes a plurality of buffers spaced from each other such that a vertically moving mass is received at least partially between the buffers before the buffers interact with the mass.

In one example, the buffers each have a height relative to a floor surface in a pit and the mass moves closer to the floor surface than the height before the buffers interact with the mass. In one example, the moving mass is a counterweight that includes a strike member that contacts the buffers and the strike member is positioned near a top of the counterweight.

In one example, the buffers are aligned with guide rails that guide vertical movement of the mass such that the buffers are between the guide rails and at least a portion of the mass is received between the buffers.

The various features and advantages of this invention will become apparent to those skilled in the art from the following detailed description of the currently preferred embodiment. The drawings that accompany the detailed description can be briefly described as follows.

### BRIEF DESCRIPTION OF THE DRAWINGS

FIG. 1 schematically shows selected portions of an elevator system.

FIG. 2 schematically shows an example buffer assembly designed according to an embodiment of this invention.

### DETAILED DESCRIPTION OF THE PREFERRED EMBODIMENTS

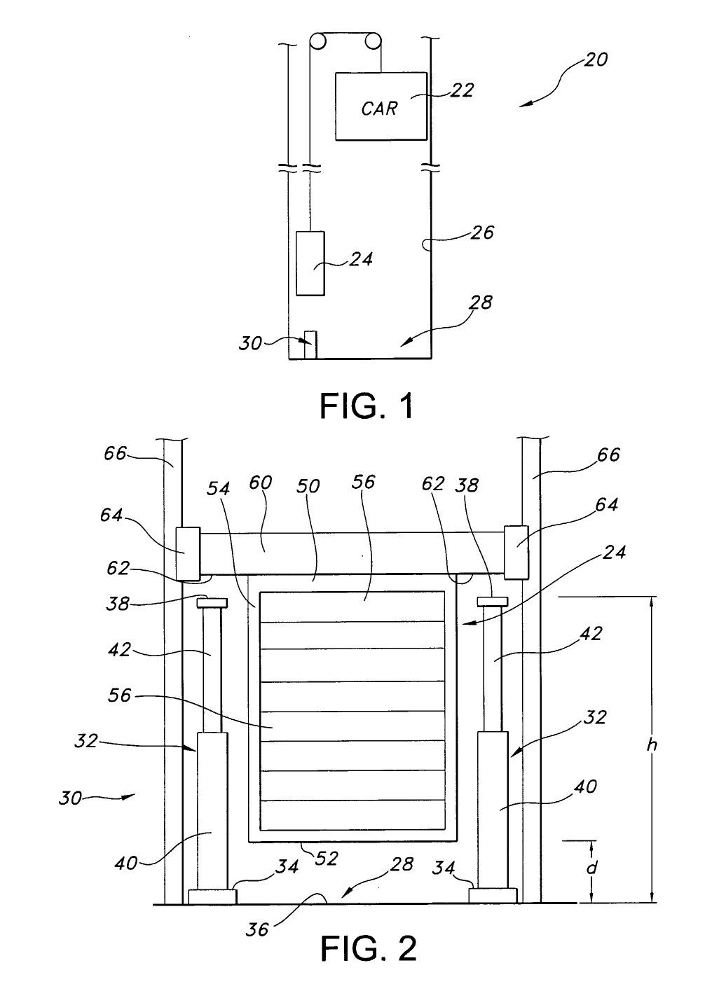

FIG. 1 schematically shows selected portions of an elevator system 20 including a car 22 and counterweight 24 that move within a hoistway 26 in a known manner. A lower portion of the hoistway 28 includes a buffer assembly 30 that cushions downward movement of the counterweight 24 under selected conditions in a generally known manner. In one example, the buffer assembly 30 is positioned within a pit at the bottom of the hoistway 26.

The buffer assembly 30 minimizes occupied space by allowing at least a portion of the counterweight 24 to move below an uppermost portion of the buffer assembly before the buffer assembly interacts with the counterweight.

FIG. 2 schematically shows an example arrangement of one buffer assembly 30. In this example, a plurality of buffers 32 are spaced apart such that a portion of the counterweight 24 is received between the buffers 32 before the buffers interact with the counterweight 24. One difference between the buffer assembly 30 shown in FIG. 2 and conventional arrangements is that a plurality of buffers 32 are spaced apart instead of having a single buffer positioned beneath a central portion of the counterweight 24.

In the illustrated example, the buffers 32 have a lower portion 34 that is secured in a fixed position relative to a surface 36 near the bottom 28 of the hoistway 26. In one example, the surface 36 is a bottom surface in a pit. An opposite end 38 of the buffers 32 is distal from the surface 36. The ends 38 of the buffers 32 define a height h of the buffers 32 relative to the surface 36.

In the illustrated example, the buffers 32 comprise a first stationary portion 40 and a second, moveable portion 42. The second portions 42 move relative to the first portions 40 in a known manner responsive to contact with the counterweight 24. In one example, the buffers 32 comprise springs. In one example, each buffer 32 includes a coil spring that biases the distal end 38 toward the uppermost position shown in FIG. 2. Another example includes gas springs. Another example includes a hydraulic arrangement that controls movement of the second portions 42 relative to the first portions 40. A variety of buffer configurations may be used in a buffer assembly designed according to this invention. Given this description, those skilled in the art will be able to select from among known types of buffers to meet the needs of their particular situation.

In FIG. 2, the example counterweight 24 includes a frame comprising a top portion 50, a bottom portion 52 and side portions 54. A plurality of known fillers 56, such as plates, are supported within the frame to achieve the desired mass of the counterweight 24. In this example, a strike member 60 is supported near the top member 50 of the frame. The strike member 60 in one example comprises a strike plate. Strike surfaces 62 are positioned to contact the distal ends 38 of the buffers 32 when the counterweight 24 moves to a sufficiently low position. The strike surfaces 62 preferably are arranged relative to the structure of the counterweight 24 such that they make contact with the distal ends 38 of the buffers 32 in time to achieve adequate energy absorption while still allowing at least a portion of the counterweight 24 to move to a position lower than the distal ends 38 of the buffers 32. In the example of FIG. 2, a distance d between a lowermost portion of the counterweight (i.e., the frame portion 52) and the surface 36 is greater than the stroke of the buffers 32 when contact is made between the strike surfaces 62 and the distal ends 38 of the buffers 32.

In the illustrated example, the strike member 60 provides a mounting surface for guides 64 that guide movement of the counterweight 24 along guide rails 66 in a known manner. The guides 64 are schematically shown and may comprise any known guide for such a purpose.

In another example, the strike member 60 is positioned more centrally on the counterweight 24.

The example arrangement shows how a plurality of buffers spaced apart sufficient to allow a portion of a vertically moving mass (i.e., a counterweight) to be received between the buffers accommodates a greater range of motion of the moving mass while still using buffers having adequate stroke to provide the necessary energy-absorbing characteristics within a given elevator system.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

I claim:

1. A buffer assembly (30) for use near a bottom of an elevator system (20), comprising:
a plurality of buffers (32) spaced from each other such that a vertically moving mass (24) is received at least partially between the buffers (32) before the buffers (32) interact with the mass (24).

2. The assembly of claim 1, wherein the buffers (32) each have a height relative to a base surface (36) and wherein the mass (24) moves closer to the base surface (36) than the height before the buffers (32) interact with the mass (24).

3. The assembly of claim 1, wherein each buffer (32) has one end (34) secured in a selected position adjacent a surface (36) and a distal end (38) spaced from the one end (34) and wherein the distal ends (38) contact a portion (60) of the mass (24) after at least some of the mass (24) moves vertically below the distal ends (38) and before any of the mass (24) contacts the surface (36).

4. The assembly of claim 1, wherein the buffers (32) at least partially compress to absorb energy associated with movement of the mass (24) when the buffers (32) interact with the mass (24).

5. The assembly of claim 4, wherein the buffers (32) comprise springs.

6. The assembly of claim 4, wherein the buffers (32) comprise a stationary portion (40) and a moveable portion (42) that moves relative to the stationary portion (40) when the buffers (32) interact with the mass (24).

7. An elevator system (20) comprising:
an elevator car (22);
a counterweight (24) coupled with the elevator car (22); and
a plurality of buffers (32) positioned beneath the counterweight (24) and spaced apart from each other such that at least a portion of the counterweight (24) is received between the buffers (32) before the buffers (32) interact with the counterweight (24).

8. The system of claim 7, wherein the counterweight (24) includes a strike member (60) that contacts the buffers (32) when a lowest portion (52) of the counterweight (24) is a selected distance from a bottom (34) of the buffers (32).

9. The system of claim 8, wherein the strike member (60) is near a top of the counterweight (24).

10. The system of claim 8, wherein the strike member (60) is between a top and a bottom of the counterweight (24).

11. The system of claim 8, wherein each buffer (32) has one end (34) secured in a selected position adjacent a surface (36) and a distal end (38) spaced from the one end (34) and wherein the strike member (60) contacts the distal ends (30) before the lowest portion (52) of the counterweight (24) contacts the surface (36).

12. The system of claim 11, wherein the strike member (60) is positioned on the counterweight (24) such that the distance between the lowest portion (52) of the counterweight (24) and the surface (36) is less than a stroke of the buffers (32).

13. The system of claim 7, wherein the buffers (32) at least partially compress to absorb energy associated with movement of the counterweight (24) when the buffers (32) interact with the counterweight (24).

14. The system of claim 13, wherein the buffers (32) comprise springs.

15. The system of claim 13, wherein the buffers (32) comprise a stationary portion (40) and a moveable portion (42) that moves relative to the stationary portion when the buffers (32) interact with the counterweight (24).

16. The system of claim 7, including two spaced guide rails (66) that guide movement of the counterweight (24) and wherein the buffers (32) are between the guide rails (66).

17. The system of claim 16, wherein the buffers (32) are positioned on a line extending between the guide rails (66).

18. A method of controlling a lowermost position of a counterweight (24) in an elevator system (20), comprising:
arranging a plurality of buffers (32) such that at least a portion of the counterweight (24) is received between the buffers (32) before the buffers (32) interact with the counterweight (24) as the counterweight (24) approaches the lowermost position.

19. The method of claim 18, including positioning a strike member (60) that is adapted to contact the buffers (32) on the counterweight (24) above a lowest portion (52) of the counterweight (24).

20. The method of claim 19, including positioning the strike member (60) near a top of the counterweight (24).
